(19) United States
(12) Patent Application Publication
(10) Pub. No.: US 2004/0114491 A1
(43) Pub. Date: Jun. 17, 2004

(54) High density optical data storage

(76) Inventors: Demetri Psaltis, Pasadena, CA (US); Christophe Moser, Pasadena, CA (US)

Correspondence Address: COUDERT BROTHERS LLP, 333 SOUTH HOPE STREET, 23RD FLOOR, LOS ANGELES, CA, 90071, US

(21) Appl. No.: 10/664,681

(22) Filed: Sep. 19, 2003

Related U.S. Application Data
(60) Provisional application No. 60/412,523, filed on Sep. 19, 2002.

(51) Int. Cl. G11B 7/00

(52) U.S. Cl. 369/108

(57) ABSTRACT

A method and apparatus for increasing data storage capabilities by inserting quantum dots in the pits of disks like CD-RWs, DVDs, WORM disks, and CD-ROM disks, exciting them with a laser diode, and measuring their fluorescence is described. Carriers of different colors are placed in each pit via quantum dots. These dots are made up of multiple colors, or different shades of a color. The quantum dots are inserted using inkjet based technology, laser-induced technology, or holey fibers. A laser diode excites the dots, making them fluoresce, which is measured by a holographic multi-spectral filter (HMSF). The HMSF diffracts the collimated fluorescence before a lens focuses each spectral component onto a detector. A dichroic beam splitter is placed under the HMSF to prohibit the light from the laser diode to reach the detector yet allow the fluoresce through.

### CROSS-REFERENCE TO RELATED APPLICATIONS

The present application claims the benefit of priority from pending U.S. Provisional Patent Applications Serial No. 60/412,523, entitled “High Density Optical Data Storage”, filed on Sep. 19, 2002, which is herein incorporated by reference in its entirety.

### BACKGROUND OF THE INVENTION

1. Field of the Invention

The present invention relates to the field of optics, and in particular to a method and apparatus of increasing data storage capacities of optical disks such as CD-ROM disks, write once read many (WORM) disks, or commercially available CD-RWs and DVDs.

Portions of the disclosure of this patent document contain material that are subject to copyright protection. The copyright owner has no objection to the facsimile reproduction by anyone of the patent document or the patent disclosure as it appears in the Patent and Trademark Office file or records, but otherwise reserves all rights whatsoever.

2. Background Art

The use of optical based storage media has become commonplace in present computer systems. In an optical disk drive, data is stored as a series of pits arranged in concentric or spiral tracks on a disk surface. The read/write head is embodied by a lens assembly which is used to project a light beam, (such as a laser beam), onto the disk surface. In an optical disk drive, the light beam is modulated by the pits in the disk and the modulated light beam is reflected from the disk to an optical pick up device which can produce an output signal dependent on the modulation of the light beam. In a magneto-optical disk drive, magnetic domains are oriented so that the polarization of a read light beam is modulated and this modulated beam is detected. The use of optical and magneto optical disks has greatly increased the capacity of removable storage in computer systems. The limitation of present optical storage systems is caused by a physical limitation defined by the geometry and spacing of pits on a disk surface. These limitations are due to formation techniques as well as wavelength limitations in laser read heads.

### SUMMARY OF THE INVENTION

The present invention provides a method and apparatus for increasing data storage capacities of media including CD-ROM disks, write once read many (WORM) disks, or commercially available CD-RWs and DVDs. One embodiment of the invention contemplates a disk that includes a plurality of pits formed in each track. Carriers of different colors are placed in each pit. The presence or absence of a color in a pit represents a bit of data. The present invention can be implemented with a plurality of colors as long as the separate colors are detectable. This typically depends on how close the wavelengths of the colors are to each other. In and example of one embodiment, three colors (e.g. red, green, and blue) may be present or absent in each pit, providing eight binary states of information (000 to 111) in each pit, thereby increasing storage capacity of pit only systems by a factor of eight. In one embodiment, the color is placed via quantum dots (nano-scale crystalline colored structures that absorb light and then reemit it in a specific color or any nanometer sized fluorescent particle or specrally selective component.) According to one embodiment of the present invention, these quantum dots are made up of the three primary colors, viz. red, blue, and green, where one configuration has red as the most significant bit followed by blue and green as the least significant bit. According to another embodiment of the present invention, an increase in data storage capacity is achieved using quantum dots comprising more than three colors so that more bits per pit can be detected.

One way of inserting the quantum dots within the pits of the disks is using inkjet based technology for mixing and depositing the quantum dots. Another way of inserting the quantum dots within the pits of the disks is using laser-induced technology for creating the quantum dots within the host material. Yet another way of inserting the quantum dots within the pits of the disks is using holey fibers to inject the dots.

According to another embodiment of the present invention, the quantum dots are illuminated by a laser diode causing the dots to fluoresce at distinct wavelengths according to their size. According to another embodiment of the present invention, the collimated fluorescence is measured by a holographic multi-spectral filter (HMSF), which diffracts the collimated fluorescence before a lens focuses each spectral component onto a detector. According to another embodiment of the present invention, a dichroic beam splitter is used to prohibit the light from the laser diode to reach the detector via the HMSF, yet allow the quantum dots to fluoresce through.

### BRIEF DESCRIPTION OF THE DRAWINGS

These and other features, aspects and advantages of the present invention will become better understood with regard to the following description, appended claims and accompanying drawings where:

FIG. 1 illustrates quantum dots embedded in the pits of a disk.

FIG. 2 illustrates one way of inserting quantum dots within the pits of a disk.

FIG. 3A illustrates metallic nanoparticles embedded within a host material.

FIG. 3B illustrates the size shaping of the nanoparticles of FIG. 4(a) above with laser pulses.

FIG. 4 illustrates how a HMSF is used in the read-out system.

FIG. 5 illustrates an architecture for fabricating a HMSF.

FIG. 6 illustrates the working principle of a HMSF.

### DETAILED DESCRIPTION OF THE INVENTION

The embodiments of the present invention are a method and an apparatus for increasing data storage capacities of CD-ROM disks, write once read many (WORM) disks, or commercially available CD-RWs and DVDs. In the following description, numerous specific details are set forth to provide a more thorough description of embodiments of the invention. It will be apparent, however, to one skilled in the art, that the embodiments of the present invention may be practiced without these specific details. In other instances, well known features have not been described in detail so as not to obscure the invention.

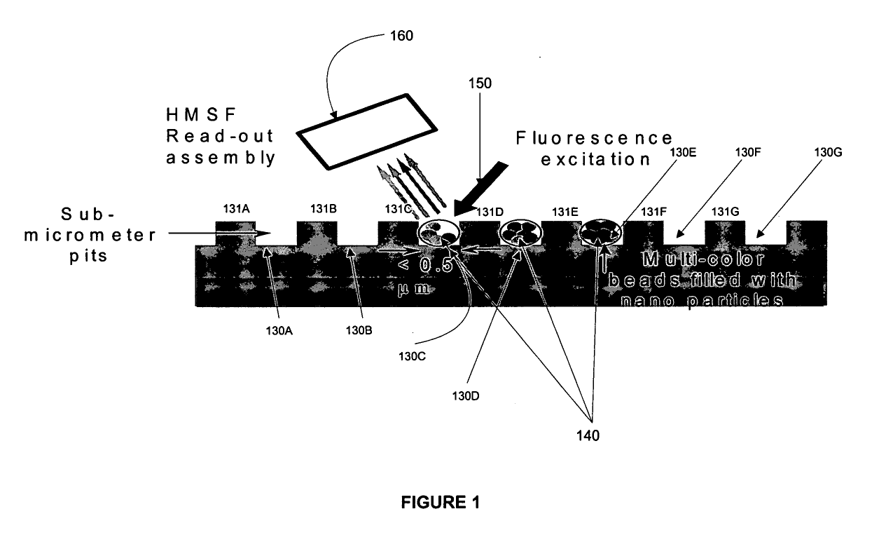

Currently each physical location on an optical disk represents a potential bit of data. The presence or absence of a pit represents a “one” or a “zero” in binary form. Referring to FIG. 1 a cross sectional view of a disk with pits is shown. The surface of the disk consists of pits (the lower areas such as 130A-130G) and “lands” (the raised areas such as 131A-131G). In operation, a laser shines on the disk and is reflected to a detector. The difference in the reflected beam caused by passing over lands and pits is interpreted as binary data and used to convey information stored on the disk. As noted previously, there are limitations to current disk drive technology which limit the amount of data that can be stored. One of the limitations is the physical dimensions of the pits and lands and the closeness of the spacing of adjacent pits in the same groove as well as adjacent grooves.

Another limitation is the size of the laser spot used for reading the disk. If the pits and lands are too small, the laser spot can overlap neighboring pits, leading to intersymbol interference and inability to resolve the stored data.

The present invention provides a method for increasing the storage capability of a disk drive regardless of the physical dimensions of the pits. That is, for any dimensions or number of pits on a disk, the present invention can increase the storage capability by several orders of magnitude. The present invention provides this advantage by multiplying the amount of data that can be stored at each pit. Instead of representing the presence of absence of a single bit of data, the present invention provides a way in which each pit can represent, for example, eight bits of data in one embodiment.

In one embodiment of the invention, each pit contains a plurality of beads of varying colors. For purposes of example, consider a system where the beads are red, green, and blue. (It should be understood that the invention may be practiced with a plurality of colors and is not limited to three). The presence or absence of beads of each color can be read by a readout assembly. As a result, each pit can represent a three bit binary state or eight states from 000 to 111, where the most significant bit (MSB) represents the presence or absence of red, the next significant bit the presence or absence of blue, and the least significant bit (LSB) the presence or absence of green. Referring again to FIG. 1, pits 130C, 130D, and 130E, each contain a plurality of beads 140. A light beam 150 provides fluorescence excitation that results in wavelengths of light being reflected to HMSF readout assembly 160. The following is a table representing the digital states that each pit can take based on the presence (digital “1”) or absence (digital “0”) of each of the colors red, green, and blue in a pit.

| Red | Green | Blue |
|---|---|---|
| 0 | 0 | 0 |
| 0 | 0 | 1 |
| 0 | 1 | 0 |
| 0 | 1 | 1 |
| 1 | 0 | 0 |
| 1 | 0 | 1 |
| 1 | 1 | 0 |
| 1 | 1 | 1 |

As can be seen, each pit now represents eight data states. The benefits of the present invention can be made clear by an example. A typical storage application is of data files consisting of documents. Consider an example of a document file that contains 9,000 alphanumeric characters. ASCII coding schemes use 8 bits for each alphanumeric (letter or number) character. Thus, a file that contains 9,000 characters requires 72,000 bits to represent its data. This means that 72,000 physical locations on the disk are used in current disk schemes. However, using the present invention, the 72,000 bits of the example can be written using only 24,000 physical locations (a reduction in space by 67%).

A further improvement can be achieved when each color bead can take on multiple shades or grey scales (i.e intensity) for a given color. If each color has three grey scales (e.g. dark red, light red, and no red), this permits each color to represent three states. This is by way of example only and the invention can be practiced with any number of grey scales of color. In general, if M is the number of colors and L the number of grey levels or shades of that color, the number of codes is L^{M} and the number of binary bits is log₂(L^{M}).

In operation the output of this embodiment is to read the analog waveform signal that results from having grey level data. The analog signal is read from the disk and is quantized at N points. The analog signal is then provided to an analog to digital converter to digitize the signal and place it in N bins. The N bins are digitized to give the binary data signal.

### Quantum Dots

According to one embodiment of the present invention, the color is placed within the pits of a disk via quantum dots. Quantum dots are nano-scale crystalline structures made from such inorganic compounds as cadmium selenide that are not only chemically relatively inert, but also have outer shells that are stable to photochemical damage. These quantum dots absorb light and then reemit it a couple of nanoseconds later in a specific color. Even though these dots contain a few thousand atoms and are a few nanometers in diameter, they exhibit properties different from the bulk material and behave as single “atom-like” quantum entities.

The emission wavelength of a quantum dot depends on its size, and therefore by controlling its size it is possible to tune the emission wavelength. The spectrum wavelength may be as little as 12 nm for a single nanocrystal. In experiments, the size homogeneity of a single quantum dot can be controlled to within 2-3%, which means that the associated linewidth broadening of a collection of single color quantum dots can reach 20-30 nm full-width half-maximum (FWHM). FIG. 1 illustrates quantum dots embedded in the pits of a disk and excited by a tightly focused blue laser diode. The quantum dots are excited by a blue laser diode, and the multi-wavelength fluorescence is decoded by a holographic multi-spectral filter (HMSF) read-out assembly. Since the minimum feature size that can be illuminated by a laser is its focus spot size, and the size of a quantum dot is much smaller than the illuminate spot size (approximately 10 nm for the quantum dot as compared to approximately 500 nm for the laser), the quantum dots are encoded spectrally within the spot size and the fluorescence is resolved in the far field as follows: A quantum dot looks like a particle of approximate size λ/N.A. in the far field, where λ is the fluorescence wavelength of the quantum dot, and N.A. is the numerical aperture of the collecting lens.

Quantum dots can be excited at many wavelengths shorter than the emission peak. This means that an ensemble of different color quantum dots can be excited simultaneously by a single source. The high excitation cross-section and high quantum yields yielding to an intense fluorescence means that each quantum dot when illuminated (or excited) acts like a molecule-sized LED. The information of each quantum dot is represented by the number of fluorescent wavelengths and the light intensity in each wavelength with the multi-wavelength fluorescence decoded by a HMSF.

According to another embodiment of the present invention, these quantum dots are inserted within the pits of the disk using inkjet based technology to mix and deposit the quantum dots.

### Inkjet Based Technology

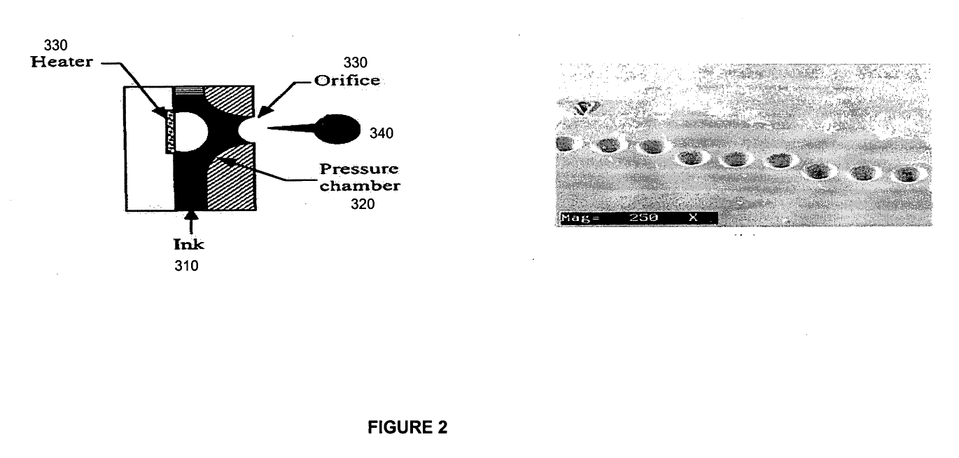

Inkjet technology is based on injecting bubbles of ink through a nozzle as illustrated in FIG. 2. FIG. 2 shows a heater element (300) that forces ink (310) through a pressure chamber (320) out an orifice (330) to jet bubbles of ink 340. The same technology may be implemented to mix and jet quantum beads into small spots. The number of different color quantum dots necessary to reach a storage density of say 1 terabit/square inch (Tb/in²) is computed as follows:

The linewidth of an ensemble of quantum dots is 20-30 nm FWHM. It is possible to pack between 25 and 38 spectral bands between 400 and 1160 nm, which matches the spectral range of standard silicon detectors. By varying the amount of quantum dots of a particular color in one bead, one can achieve various shades (or grades) of coding. Five levels of this coding, also known as gray level coding, can be achieved using the above configuration all with 99.99% identification. This identification level is shown in an article written by M. Han, et. al., entitled “Quantum-Dot-Tagged Microbeads For Multiplexed Optical Coding Of Biomolecules”, published in Nature Biotechnology 19, 631-635 (2001). This means that the number of codes with 38 wavelengths and 6 gray levels is equal to 6³⁸. This corresponds to Log₂(6³⁸), which is 98 bits of information that can be packed in one spot size of a commercial disk. Most commercial disk spot size is 0.32 μm, which means that a density of 1215 bits/μm or 0.784 Tb/in² can be achieved. This density is unparalleled by any prior art technology, and can exceed the 1 Tb/in² range by expanding the spectral range of wavelengths to the infrared and by reducing the quantum dot homogeneity, which will reduce the emission linewidth and thus increase the number of wavelengths.

The estimated time needed to write 1 Tb/in² using current inkjet technology is 42 hours. This is based on 480 number of nozzles in a single print-head, each jetting droplets at the rate of 12,000 drops/second, 6 gray levels and 38 colors, and taking into calculations only half the number of drops per spot ((((6*38)/2)*7.8*10⁹)/480*12000). This writing time is similar to that of a commercially available CD-RW, and the time can be decreased by increasing the number of nozzles and the jet rate.

### Holey Fibers

One embodiment uses holey fibers to inject the quantum dots. Holey fibers are optical fibers created and researched at Southampton University that look just like the optical fibers already widely used, for example, to send cable TV signals or make fiber-optic table lamps, the difference is that the holey fibers have tiny holes running along its length.

One way to make holey fibers so that the holes are less than 1 micron in diameter and hence small enough to jet quantum dots smaller than the size of a pit of a commercially available disk is to create stacks of tiny hollow glass tubes around a small solid glass rod to form a cylinder perhaps 3 cm across and a meter long. This is then heated up and stretched out using a fiber drawing tower (a standard piece of optical fiber creation equipment) to produce a fiber several kilometers long and about 125 microns across. On cutting the cable thus formed at any point and looking at its cross-section, shows a solid core encircled by holes each less than a micron wide.

According to another embodiment of the present invention, these quantum dots are inserted within the pits of the disks using laser induced technology for shaping the quantum dots before depositing them.

### Laser Induced Technology

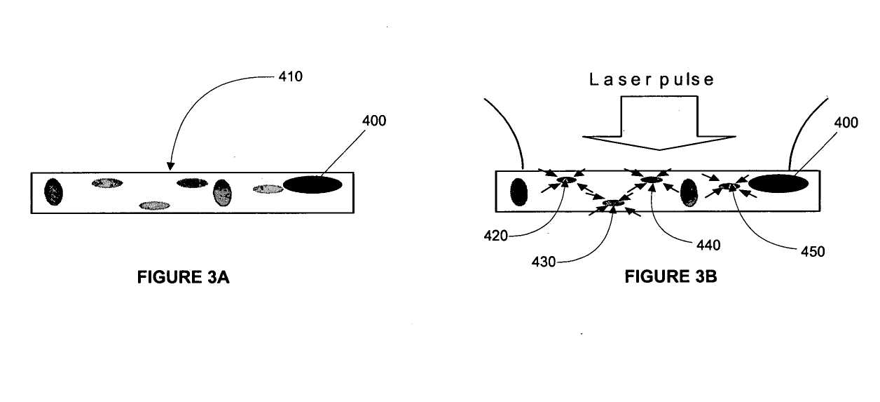

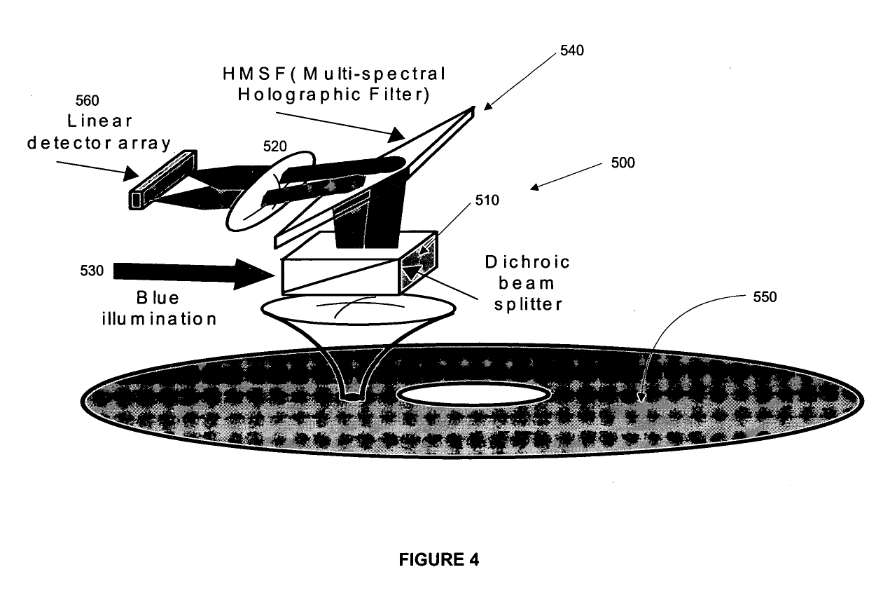

Laser induced technology is illustrated in FIGS. 3A and 3B illustrating the metallic nano-particles embedded within a host material, and the particle size shaping with laser pulses respectively. The shaping of nano-particles by laser pulses is shown in an article written by T. Wenzel, et. al., entitled “Shaping Nanoparticles And Their Optical Spectra With Photons”, published in Applied Physics B 69, 513-517 (1999). FIG. 3A illustrates a rather large particle 400 within a host material 410 having asymmetric shape before the laser pulse treatment. Upon illumination, the absorption coefficient is dependent upon the shape of the nano-particles. For particle sizes whose absorption matches that of the illuminating wavelength, the increase in heat generated by the absorption vaporizes atoms from the nanoparticles and thus reducing its size. This mechanism is seen in FIG. 3B, where nanoparticles 420, 430, 440, and 450 similar to nanoparticle 400 within a host material 410 are subjected to laser pulse 420. The nanoparticles begin to diminish in size as illustrated by the four inward arrows surrounding each of the above mentioned nanoparticles 420 through 450.

Since the fluorescence of the nanoparticles is directly proportional to its size, this technology provides a tool to selectively produce nanoparticles (quantum dots) with a wanted fluorescence color. By using different illuminating pulse wavelengths, different embedded particles can be resized. This approach has the advantage of starting with a bulk host material and using light to modify selectively its property.

According to another embodiment of the present invention, a dichroic beam splitter is used to prohibit light from a laser diode to reach a detector via the HMSF, yet allow the quantum dots to fluoresce through. Before we show how this is achieved, we will show how the HMSF is used in the read-out system, and the proposed architecture for fabricating the HMSF.

### HMSF

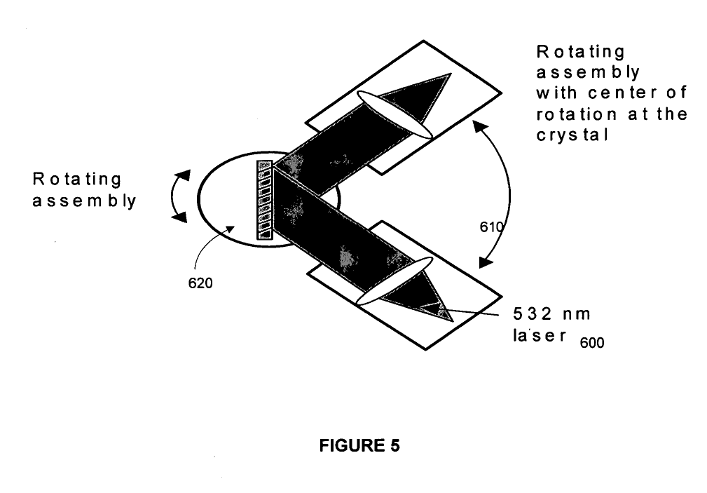

The purpose of the HMSF is to spectrally separate the colors of the fluorescent quantum dots before a detector. Because of the size constraints in the read-out head of a commercially available disk player and the large spectral range, conventional grating spectrometers do not fulfill the requirement. Even though conventional spectrometers use holographically fabricated surface relief gratings, the present invention uses a spectrometer based on multiplexed volume holographic gratings which satisfy uniquely the spectral range and size requirements for the current application. FIG. 5 illustrates how the HMSF is used in the read-out system. In the figure, read-out head 500 is composed of a dichroic beam splitter 510 that spectrally isolates the illuminating wavelength at 405 nm from the longer fluorescence wavelengths. The focusing lens 520 also collimates the fluorescence emitted by the quantum dots. The spatial coherence is excellent since the light is emitted from a sub-micron spot resulting in a highly collimated beam after the same focusing lens.

In working the blue illumination from a laser diode pulse 530 gets reflected off the dichroic beam splitter and heats up the quantum dots on disk 550. These quantum dots start to fluoresce, which is picked up by HMSF 540 before entering focusing lens 520 and being registered on a linear detector array 560. In order to separate the large range (450 to 1150 nm) of spectral components efficiently and in a compact space, a HMSF architecture illustrated in FIG. 5 is used.

### Recording of the HMSF

In the geometry of FIG. 5, a single recording wavelength of 532 nm can easily synthesize filters for the wavelength range 450 to 1150 nm. The collimated beams from a 532 nm laser (600) interferes with a holographic medium 610 with thickness 200 micrometers. The angle between the beams can be accurately (<10⁻³ degrees) varied by a rotating assembly 620 with its center of rotation centered at the recording material. The angle of the recording material with respect to the recording beams can be independently adjusted with the rotating assembly. The key advantages of using a HMSF over conventional grating spectrometers are:

(1) Compactness: the dimensions of the HMSF and the detector are expected to be approximately 1 cm³ instead of more than 100 cm³ for conventional grating spectrometers.

(2) The filtering characteristics of the HMSF are independent of the beam diameter.

(3) The diffraction angle of each color can be selected during recording to allow flexibility in the design of the lens and detector.

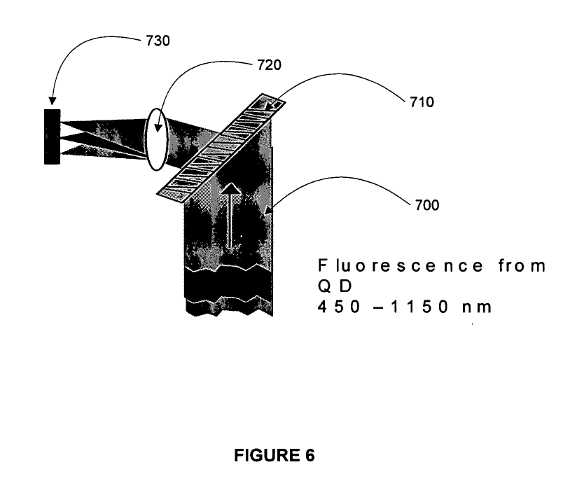

According to another embodiment of the present invention, the collimated fluorescence of the quantum dots is measured by a holographic multi-spectral filer (HMSF) that diffracts the collimated fluorescence before a lens focuses each spectral component onto a detector. FIG. 6 illustrates the working principle of the HMSF in more detail. In the figure the collimated fluorescence 700 from the quantum dots is diffracted by HMSF 710, and each spectral component is focused by a lens 720 onto a detector array 730.

The spectral selectivity is given as Δλ=λ²/L, where λ is the wavelength of the light and L is the thickness of the material. In experiments conducted, the spectral selectivity is between 1 and 6 nm when the material is 200 μm thick having a range of wavelength between 400 and 1160 nm. This narrow spectral range provides an excellent cross-talk suppression between channels even when emission bandwidth of an ensemble of quantum dots reaches 12 nm. The minimum optical power required from a blue diode laser to generate a user data at least equal to 35 Mbits/sec, which is the next generation DVD rate, is limited by the integration time of the detector, and is calculated as follows:

Tint=hvNₑ/P_{source} η_{TOT}, where h is the Planck's constant, v is the frequency of the detected light, Nₑ is the required number of electrons generated at the detector to obtain a minimum signal-to-noise ratio, P_{source} is the power of the laser light, and η_{TOT} is the total efficiency of the HMSF given by:

η_{TOT}=η_{fluorescence}*η_{hologram}*(filter bandwidth/emission bandwidth)*η_{detector},

where, η_{fluorescence} is the fluorescence efficiency, η_{hologram} is the diffraction efficiency of the HMSF, and η_{detector} is the quantum efficiency of the detector. Inserting the numerical values for the variables in the equation for the integration of time, one finds that the total power to achieve 35 Mb/sec is equal to a couple of milliwatts, which is already achievable by current blue laser diodes. This means that using the methods of the present invention, one can increase the data read-out rate well beyond the next generation DVD read rate.

Thus, a method and apparatus for inserting quantum dots in the data layer of commercial CD-RWs and DVDs, exciting them with a laser diode, and measuring their fluorescence is described in conjunction with one or more specific embodiments. The embodiments of the present invention are defined by the following claims and their full scope of equivalents.

We claim:

1. A method of storing data comprising:
placing a plurality of carriers of different colors on a medium and representing data by the presence and absence of said colors;
exciting said colors within said carriers by making them fluoresce;
measuring said fluoresce of said carriers to identify presence and absence of said colors.

2. The method of claim 1 wherein said medium is a disk.

3. The method of claim 1 wherein said carriers are nanometer size fluorescent particles.

4. The method of claim 3 wherein said particles comprise quantum dots.

5. The method of claim 4 wherein said quantum dots are made up of red, blue, and green color.

6. The method of claim 4 wherein said quantum dots are made up of a plurality of shades of a color.

7. The method of claim 1 wherein said placing of said carriers is performed using inkjet based technology.

8. The method of claim 1 wherein said placing of said carriers is performed using laser-induced technology.

9. The method of claim 1 wherein said placing of said carriers is performed using holey fibers.

10. The method of claim 1 wherein an HSMF is used for dispersing collimated fluorescent light on a specrally sensitive component.
